(19) United States
(12) Patent Application Publication
(10) Pub. No.: US 2007/0066709 A1
(43) Pub. Date: Mar. 22, 2007

(54) Manufacturing method for ambient temperature self-curable system of water borne-based polymeric ink

(75) Inventors: Kan-Nan Chen, Taipei (TW); Ching-Tzer Huang, Taipei (TW)

Correspondence Address: BACON & THOMAS, PLLC, 625 SLATERS LANE, FOURTH FLOOR, ALEXANDRIA, VA, 22314, US

(73) Assignee: Tamkang University, Taipei Hsien (TW)

(21) Appl. No.: 11/229,513

(22) Filed: Sep. 20, 2005

(51) Int. Cl. C03C 17/00

(52) U.S. Cl. 523/160

(57) ABSTRACT

A manufacturing method for ambient temperature self-curable system of water borne based polymeric ink is disclosed by using a carboxyl group containing water borne-based polymer as a base of polymeric dye and reacting the isocyanate or epoxy group of this polymer with dye to form a water borne-based polymeric dye, then neutralizing this water borne-based polymeric dye to form a water borne polymeric dye dispersion, adding a latent curing agent to get a single-pack ambient temperature self-curable system of water borne polymeric ink. This new stable water borne-based polymeric ink becomes water-resistant and solvent-proof after drying at ambient temperature due to a curing reaction takes place between aziridine of curing agent and carboxylic acid of polymeric dye when its pH drops to and below 7.0 on drying. The application of this self-curable water borne polymeric ink has neither organic solvent emission nor energy needed for curing. It is not only meets the requirements of environmental, safety and industrial hygiene but also solves the water-resistance handicap of the conventional water borne-based ink.

### FIELD OF THE INVENTION

This invention relates to a manufacturing method for ambient temperature self-curable system of water borne-based polymeric ink, especially by reacting water soluble or solvent soluble dye having reactive amino group with water borne polymeric resin to get chemical linkage between the reactive amino group of dye and water-borne polymeric resin to allow dye to become a part of water borne polymeric material so as to water borne dye dispersion, then adding latent polymeric cross linking agent of the water borne polymeric material to get single pack ambient temperature self-curable water borne-based polymeric ink.

### DESCRIPTION OF THE PRIOR ART

Most dyes are either water soluble or organic solvent soluble for printing, writing and dyeing purposes. Water-soluble dyes are suitable for water borne-based dye (or ink). It exhibits excellent color extension on printing, writing and dyeing applications, however, its good water solubility induces to the poor color fastness. Organic soluble dyes are used only solvent-based or emulsion process. Most dyes of neither water resistant nor solvent proof after application is the limitation for these conventional dyes.

In the present, the water borne ink used for claiming environmental protection whatever in writing, printing or jet printing is not water resistant, a protective transparent film should be applied onto the document surface after using to make some inconvenience for user.

How to incorporate dye into water borne resin to enhance color extension and utilize the cross linkage reaction of polymer to cause the water borne dye drying onto paper for the acidic jet ink or writing paper (pH of the papers always below 6.0) to become water resistant ink is a long felt problem to be solved.

### BRIEF SUMMARY OF THE INVENTION

To solve the above mentioned problem, the inventors made efforts to find by using the cross linking reaction of polymer to improve the water resistance of this water borne dye, i.e. by using latent polymeric cross linking agent and the hydrophilic group of this water borne dye to undergo cross linkage reaction to eliminate the hydrophilic group of this water borne dye and also enhance the cross linkage density to improve the water resistance. In particular, a manufacturing method of ambient temperature self-curable system of water borne-based polymeric ink is disclosed by reacting water soluble or solvent soluble dye having reactive amino group with water borne polymeric resin to get chemical linkage between the reactive amino group of dye and water-borne polymeric resin to allow dye to become a part of water borne polymeric material and to get water borne dye dispersion, then adding latent polymeric cross linking agent of the water borne polymeric material such as a polyaziridine containing compound to get single pack ambient temperature self-curable water borne-based polymeric ink.

A single pack ambient temperature self-curable water borne-based polymeric ink obtained by this invention can make use of the conventional dyes (water or solvent soluble) having amino group reacting with water borne polymer and becoming part of water borne polymeric dye dispersion, then adding a polyaziridine containing compound as latent curing agent to get stable single-pack self-curable water borne polymeric dye dispersion. It is a stable water borne dispersion during storage at pH greater than 8.0 and self-cured after application. These self-cured polymeric dyes are water and solvent resistant even dry at ambient temperature.

### DETAILED DESCRIPTION OF THE INVENTION

The conventional dyes (water or solvent soluble) having amino group of commercial available dye (disperse dye, acid dye or direct dye) is selected to react toward water borne polymers and becomes part of polymeric dye dispersion. A polyaziridine containing compound is added into this water borne polymeric dye dispersion as latent curing agent and results in a single-pack self-curable system of water borne polymeric dye dispersion. It has potential for printing ink and dyeing applications.

Water borne polymers used in this invention can be selected from one or more than one of the group of carboxyl groups containing polyurethane (PU) (hereinafter referred as PU based polymer), epoxy resin (hereinafter referred as epoxy based polymer) and modified acrylate copolymer resin having epoxy group (hereinafter referred as acrylate based copolymer). These three different types of self-emulsified or water-reducible water borne polymers can offer the polymer moiety for supporting various dyes (such as direct dye, acid dye, or disperse dye). The water borne polymeric dye dispersions obtained have the average particle size distribution in a range of 40-80 nm. The internal ionic carboxyl groups not only stabilize water borne polymer dispersions but also provide the curing sites for post self-curing reaction of polymeric dye on drying.

A polyaziridine containing compound is added as a latent curing agent in the water borne polymeric dye dispersion to form a single pack self-curable polymeric dye dispersion. This polymeric dye dispersion (e.g. for ink applications) is self-cured on drying or when its pH drops to 6.0. The preparation of the above mentioned water borne polymeric dye is shown as follows:

Water borne PU based polymer having NCO-terminated PU pre-polymer of 4% NCO content is obtained from the addition reaction of polyglycols (e.g. material PPG-1000 (poly(oxypropylene) glycol) available from Arco Chemical Co.), dimethylol propanic acid (DMPA), and excess amount of isophorone diisocyanate (IPDI). An amino containing dye (organic solvent soluble disperse dye) is selected to react toward NCO-terminated PU pre-polymer and results in a formation of polymer dye with PU polymer moiety. Its carboxylic acid is neutralized with triethylamine (TEA) and then is dispersed into water phase and finally becomes stable water borne PU based polymeric dye. The preparation process of PU based polymeric dye is illustrated as Scheme I (preparation process of PU based polymeric dye).

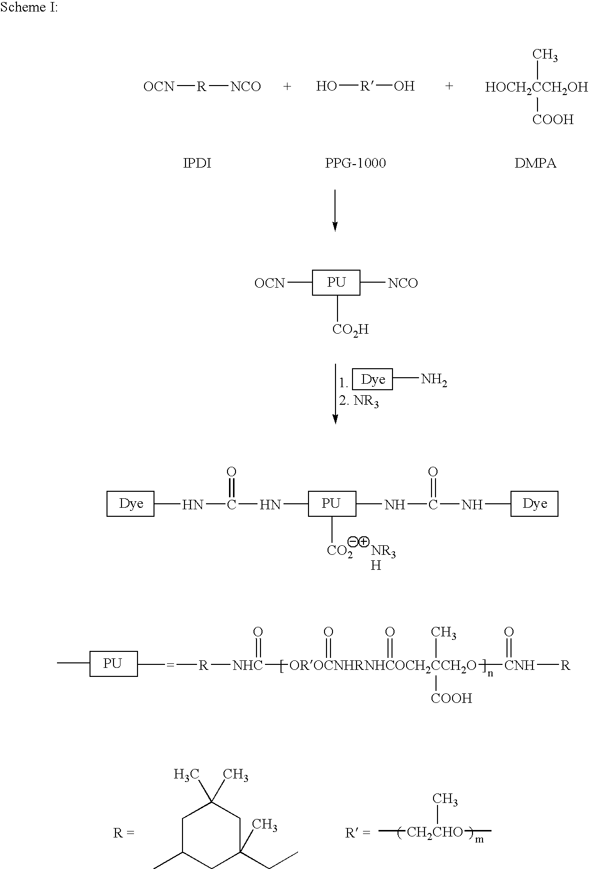

Water borne epoxy based polymer is obtained from a commercial available epoxy resin with EEW (epoxy equivalent weight) 780-850 (for example, trade name of NPES-904 available from Nan Ya Plastics Corporation, Taiwan) as a starting material. Its secondary hydroxyl group reacts via a half-esterification with succinic anhydride or maleic anhydride. The remaining carboxylic acid after the half-esterification is neutralized with TEA (triethylamine) and then is dispersed into water phase. It results in the formation of water borne epoxy resin having free terminated epoxides. A water-soluble amino containing dye such as acid dye or direct dye is selected to react with epoxide group and form a dye chemically bonded water borne epoxy based polymeric dye. The preparation process is illustrated as Scheme II (preparation process of epoxy based polymeric dye).

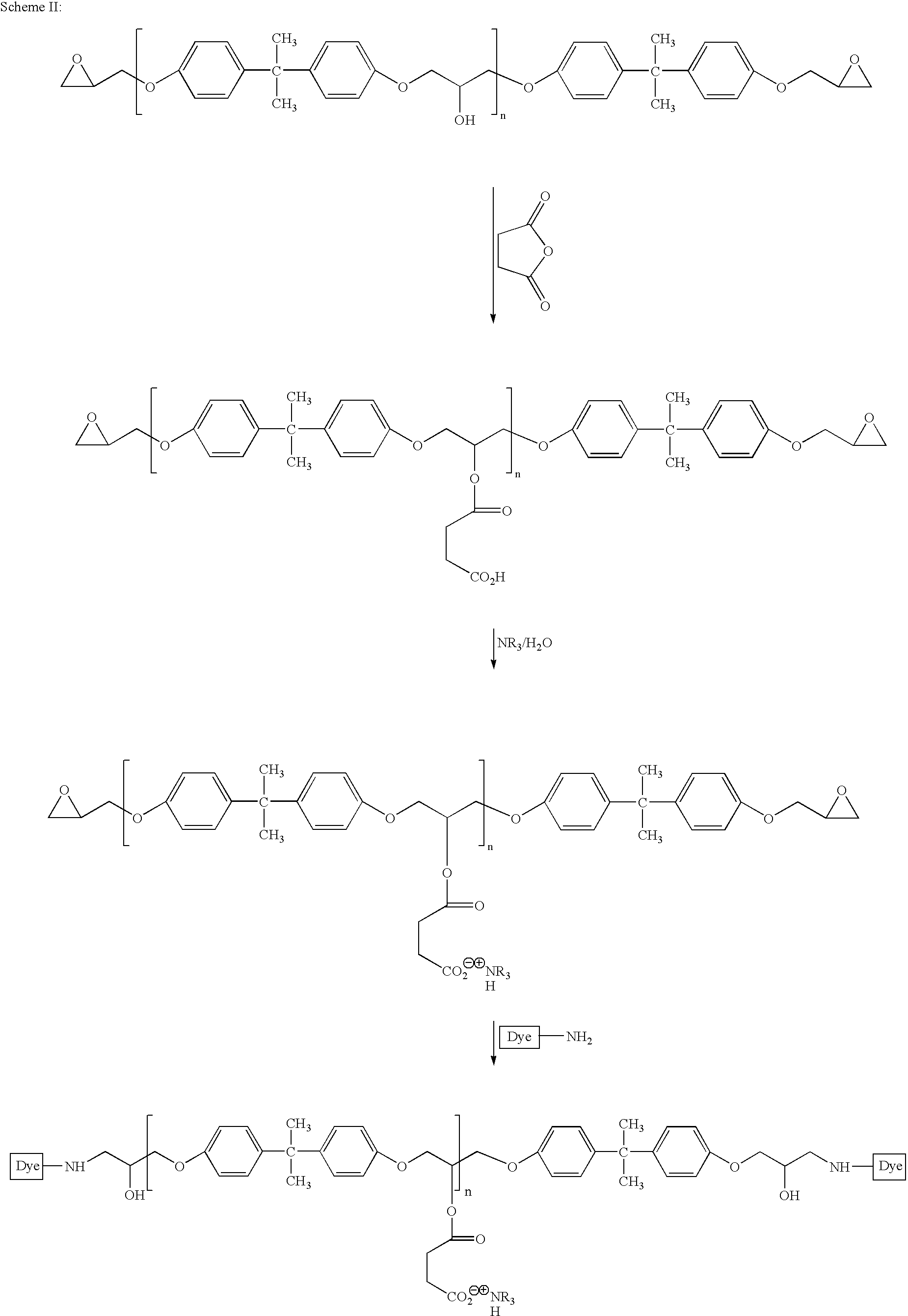

Water borne acrylate based copolymer is prepared from a copolymerization of acrylic acid, glycidyl methacrylate (GMA) and alkyl acylate via free-radical polymerization process (Scheme III) and then is neutralized with TEA. The water borne acrylate based polymeric dye is similar to water borne epoxy based polymeric dye. The preparation process is illustrated as Scheme III (preparation process of acrylate based polymeric dye).

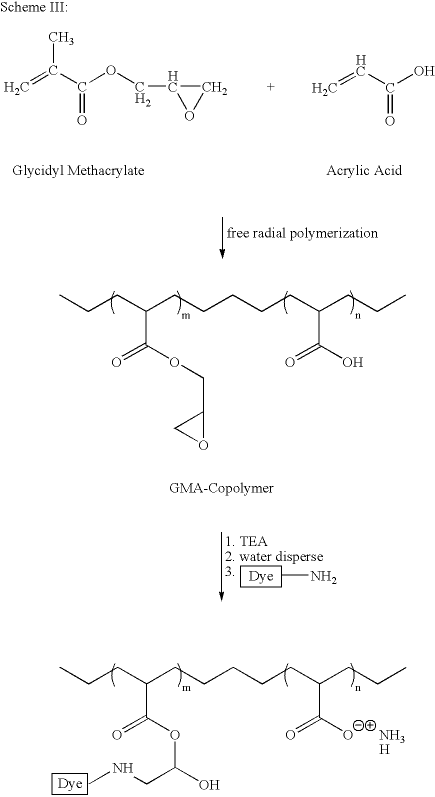

Water borne PU based polymer having carboxyl groups, water borne epoxy based polymer and water borne acrylate based copolymer used in manufacturing ambient temperature self-curable system of water borne-based polymeric ink by this invention serves as an internal surfactant for stabilizing the self-emulsified water borne polymeric dye dispersion and also serves as a reactive site toward the latent curing agent, a polyaziridine containing compound.

Most dyes used in this invention are amino containing dye (either water soluble or organic solvent soluble dye) for the preparation of water borne polymeric dye dispersion, which have the potential applications for printing, jet ink and etc.

An organic solvent soluble amino-containing dye (e.g. disperse dye) reacts with NCO-terminated PU prepolymer and becomes PU based polymeric dye before water dispersion. The PU based polymeric dye can be neutralized with triethylamine and then dispersed into water phase and results in the formation of water borne PU based polymeric dye dispersion (refer to Scheme I).

Water borne epoxy based polymer is obtained from a half-esterification with succinic anhydride or maleic anhydride. The remaining carboxylic acid after the half-esterification is neutralized with TEA and then is dispersed into water phase. An amino containing water-soluble dye (e.g. acid dye or direct dye) is selected to react with epoxide group and results in the formation of dye chemically bonded water borne epoxy based polymeric dye dispersion (refer to Scheme II).

Water borne acrylate based copolymer is obtained from a co-polymerization process of acrylic acid, alkyl acrylate and glycidyl mathacrylate (GMA). The dye chemically bonded water borne acrylate based polymeric dye dispersion is prepared similar to water borne epoxy based polymeric dye dispersion (refer to Scheme II). Carboxylic acid pendant in the water borne acrylate based copolymer can be neutralized with TEA and then is dispersed into water phase. An amino containing water-soluble dye is selected to react with epoxide group and results in the formation of dye chemically bonded water borne acrylate based polymeric dye dispersion (refer to Scheme III).

A disperse dye (organic solvent soluble dye) and a direct or an acid dye (water soluble dye) is chemically anchored on water borne-based polymer backbone and becomes part of water borne polymeric dye. The carboxyl group containing polymeric moiety is self-emulsified and stable in the water borne phase, when its pH is kept at 8.0 or above. The ratio (w/w) of dye respective to water borne polymers are in the range of 0.1/100 to 10.0/100, depending on the color strength on application.

Polyaziridine (or polyethylenimine) containing compound (such as TMPTA-AZ (trimethylolpropanetris(aziridinylpropionate)), HDDA-AZ (1,6-hexanediolbis(aziridinylpropionate))) used in this invention is selected as a latent curing agent for these water borne polymeric dye dispersions and forming a single pack self-curable polymeric dye. The curing reaction between polyaziridine and water borne polymeric dye dispersion takes place on drying at ambient temperature or when its pH value drops to or below 6.0. These self-cured polymeric dyes are water and organic solvent resistant due to their networked polymeric structure formation. The self-curing reaction of polymeric dye with latent curing agent is illustrated as Scheme IV (self-curing reaction of polymeric dye).

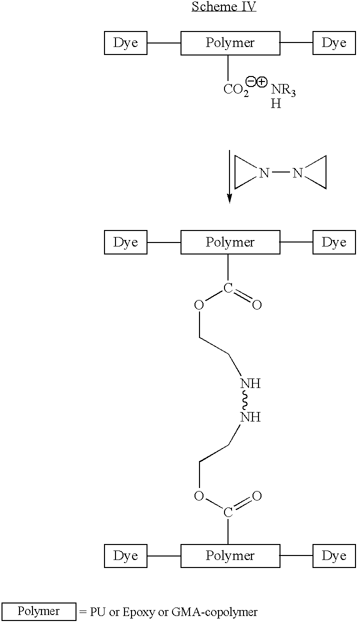

Due to these water borne polymeric dyes comprise carboxyl group and self-emulsified or water-reducible water borne polymeric dye dispersions that can be mixed with any ratios, in order to meet different requirements on various color selection and application. The self-curing with latent curing agent on these mixed water borne polymeric dyes is similar to the single polymeric dye. The mixed polymeric dye dispersion and self-curing are illustrated as Schemes V (self-curing reaction of mixed polymeric dyes) and VI (different color of dyes bonded to water borne epoxy resin).

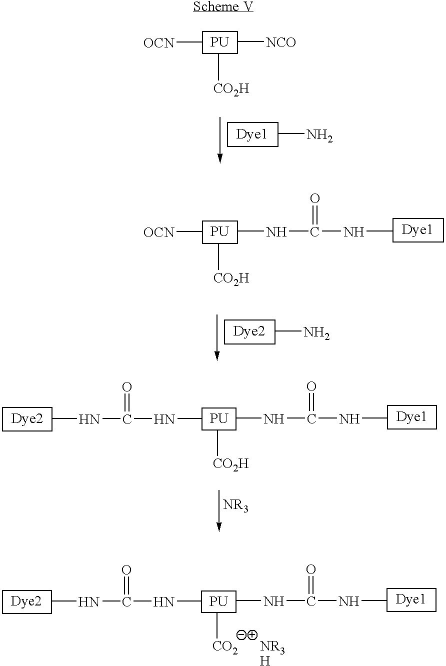

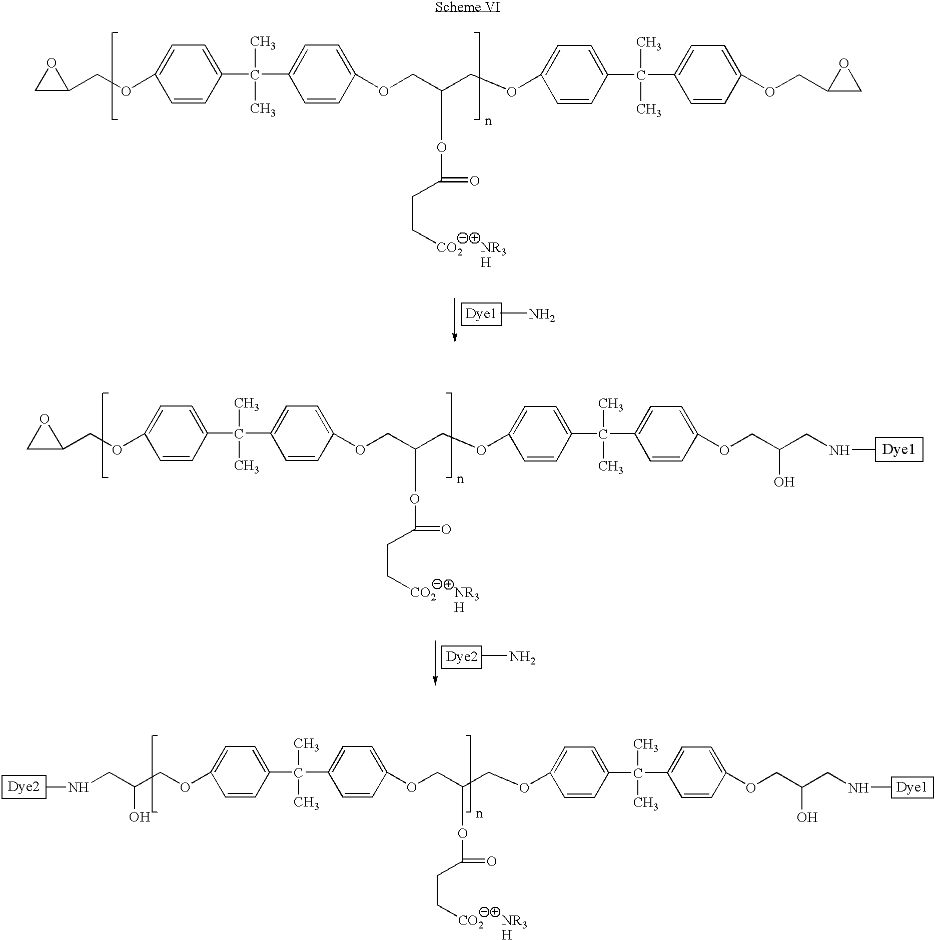

Different dyes are selected to react and chemically bonded with the same water borne polymer and results in a different color polymeric dyes, the color appearance depends on the ratio of different dyes used.

### DESCRIPTION OF THE PREFERRED EMBODIMENTS

The following examples serve to illustrate the preferred embodiment of the present invention but the present invention is not introduced to be limited to the details thereof.

### Synthesis Example 1

### Synthesis of Polyurethane Prepolymer Containing Carboxylic Group

0.1 mole of PPG-1000 (available from Arco Chemical Co.) and 0.1 mole of DMPA (C.P, grade dimethylol propanic acid, available from Aldrich Chemicals Co.) are dried at 110° C. overnight before being mixed with 0.4 moles of IPDI (isophorone diisocyanate) in a 1 L 4-neck flask equipped with mechanical stirrer, a thermometer, a nitrogen inlet, and a condenser with CaCl₂ drying tub. The reaction mixture is heated and kept at 110° C. for about 4 hours under nitrogen atmosphere, until NCO % drops below 3.5 (according to ASTM D1638 NCO determination method) and remains constant for another half hour and then cooled down at ambient temperature to get the PU-prepolymer for polymeric dye preparation process.

### Synthesis Example 2

### Synthesis of Aziridine Monomer

A 5-L, 3-neck flask containing 100 ml of 14% sodium hydroxide solution and fitted with an addition funnel, a stirrer and a condenser arranged for distillation was heated in a safety heater until distillation was proceeding at a rapid rate. Then 420 g of 2-aminoethyl hydrogen sulfate dissolved in a cool alkali solution made from 250 g of sodium hydroxide and 1800 ml of water was added to the distillation flask through the addition funnel at a rate such that amount of liquid in the flask remained about constant. The superheated distillate which came over at about 110° C. was collected in a second 5-L, 3-neck flask which fitted with an upright ice-water condenser.

After the distillation was complete, the receiving flask was fitted with two upright ice-water condensers to provide adequate cooling and a mechanical stirrer. The imine was salted out by adding 1200 g of solid sodium hydroxide to the distillate through one of the condenser. While salting out, the temperature of the distillate was not allowed to rise much above room temperature. The aziridine monomer, which was separated with a separator funnel weighed 107 g and boiled at 56° C. Redistilled aziridine also boils at 56° C. The yield obtained by this flash distillation procedure was 83% based on the 2-amionethyl hydrogen sulfate.

### Synthesis Example 3

### Synthesis of HDDA-AZ (1,6-hexanediolbis(aziridinylpropionate))

1,6-hexanediol diacrylate 11.3 g (0.05 mole) in Erlenmeyer flask, aziridine monomer (obtained from Synthesis Example 2) 6.5 g (0.15 mole) drop in Erlenmeyer flask slowly, use stir bar to stir for 50 min will get the 1,6-hexanediol bis(aziridinylpropionate) (HDDA-AZ). Add some NaOH or triethylamine to keep the product basic, seal and put in icebox.

### Synthesis Example 4

### Synthesis of TMPTA-AZ (trimethylolpropanetris(aziridinylpropionate))

Change the initiator for Trimethylolpropane triacrylate, the other steps and operation conditions are the same with synthesis example 3.

### Synthesis Example 5

### Synthesis of TPGDA-AZ (tripropylene glycol bis(aziridinylpropionate))

Change the initiator for Tripropylene glycol diacrylate, the other steps and operation conditions are the same with synthesis example 3.

### Preparation Example 1

### Preparation of Water Borne PU Based Polymeric Dye Dispersion

An acetone solution of 0.03 gm disperse dye with 2 drops of dibutyl tin dioctanoate (C.P. grade, trade name T-12 of Aldrich Chemicals Co.) as a catalyst is added into an acetone solution of the NCO-terminated PU pre-polymer (41.0 gm) obtained from Synthesis Example 1 slowly through an addition funnel (the mole ratio of NCO-terminated PU pre-polymer to dye is 200:1). 0.15 mole of triethylamine (TEA) is added to neutralize the carboxylic acid pendant in the NCO-terminated PU pre-polymer obtained from Synthesis Example 1. Then the product obtained is dispersed with 100 ml de-ionized water to get a water borne PU based polymeric dye dispersion with 20% solid content after water mixing. The disperse dye used can be one or more than one selected from the group of C. I. Disperse Blue 56, C. I. Disperse Red 4 and C. I. Disperse Yellow 9, for preparing water borne PU based polymeric dye dispersion.

### Preparation Example 2

### Preparation of Water Borne Epoxy Based Polymeric Dye Dispersion

An epoxy resin oligomer (50 gm, trade name of NPES-904 available from Nan Ya Plastics Corporation, Taiwan, EEW: 815) and 12 gm of succinic anhydride were mixed with methyl isobutyl ketone (MIBK, 50 mL) in a 500 mL 3-neck flask and add 2 drops of dibutyl tin dioctanoate (C.P. grade, trade name T-12 of Aldrich Chemicals Co.) as a catalyst. The semi-esterification reaction was carried out and kept at 120° C. for about 18 hr. Cooling the product obtained to room temperature and the unreacted succinic anhydride was removed by THF (tetrahydro furan) extraction. Neutralized the final reaction mixture with triethylamine (TEA) to get a water borne epoxy based polymeric dye dispersion and then dispersed with 45 mL de-ionized water by agitation. Water borne polymeric dye was obtained from a reaction of amino containing dye 0.5 gm with the epoxide end-groups of the water borne epoxy based polymeric dye dispersion (dye/epoxy resin=1/100, w/w). Water soluble dyes used in the above mentioned reaction can be selected from the dyes having amino group and sulfonate, such as C. I. Acid Blue 62, C. I. Direct Orange 39 and C. I. Direct Red 2 respectively.

### Example 1

### Water Borne PU Based Polymeric Dye Mixed with Curing Agent (HDDA-AZ) to Get Single Pack Self-Curable Water Borne-Based Polymeric Ink

50 gm of water borne PU based polymeric dye obtained from Preparation Example 1 (one or than one dyes selected from the group of C. I. Disperse Blue 56, C. I. Disperse Red 4 and C. I. Disperse Yellow 9) is mixed with 5 phr (part hundred resin) of aziridine curing agent 1,6-hexanediol bis(aziridinylpropionate) (HDDA-AZ) to get single pack self-curable water borne-based polymeric ink. This mixed ink will not dissolve in water when dried under ambient temperature and the dye of the single pack self-curable water borne-based polymeric ink also not be washed out when dipped in water. The gel content of the dried ink can be improved from 0% to 95%.

### Example 2

Change the Curing Agent for TMPTA-AZ (trimethylolpropanetris(aziridinylpropionate)), the other steps and operation conditions are the same with Using Example 1, the gel content of product maybe over 95%.

### Example 3

Change the curing agent for TPGDA-AZ (tripropylene glycol bis(aziridinylpropionate)), the other steps and operation conditions are the same with Example 1, the gel content of product maybe over 95%.

### Example 4

### Water Borne Epoxy Based Polymeric Dye Mixed with Curing Agent (HDDA-AZ) to Get Single Pack Self-Curable Water Borne-Based Polymeric Ink

50 g of water borne epoxy based polymeric dye obtained from Preparation Example 2) (one or than one dyes selected from the group of C. I. Acid Blue 62, C. I. Direct Orange 39 and C. I. Direct Red 2) is mixed with 5 phr (part hundred resin) of aziridine curing agent 1,6-hexanediol bis(aziridinylpropionate) (HDDA-AZ), this mixed ink will not dissolve in water when drying under ambient temperature and the dye in this mixed ink also not be washed out when dipping in water. The gel content can be improved from 0% to 90%.

### Example 5

Change the curing agent for TMPTA-AZ (trimethylolpropanetris(aziridinylpropionate)), the other steps and operation conditions are the same with Using Example 4, the gel content of product maybe over 90%.

### Example 6

Change the curing agent for TPGDA-AZ (tripropylene glycol bis(aziridinylpropionate)), the other steps and operation are the same with Using Example 4, the gel content of product can above 90%.

### Example 7

### Water Borne PU Based Polymeric Dye Hybrid with Water Borne Based Epoxy Resin to Get Single Pack Self-Curable Water Borne-Based Polymeric Ink System

Three kinds of water borne PU based polymeric dyes obtained from Preparation Example 1) is mixed with the same volume of water borne based epoxy resin, and 5 phr of curing agent (HDDA-AZ (1,6-hexanediolbis(aziridinylpr-opionate)) is added in mixture solution. These mixed inks will not dissolve in water when drying under ambient temperature and dyes in the mixed ink also not be washed out when dipping in water. The gel content can reach to 95%.

### Example 8

Change the curing agent for TMPTA-AZ (trimethylolpropanetris(aziridinylpropionate)), the other steps and operation are the same with Example 7, the gel content of product maybe over 95%.

### Example 9

Change the curing agent for TPGDA-AZ (tripropylene glycol bis(aziridinylpropionate)), the other steps and operation are the same with Using Example 7, the gel content of product maybe over 95%.

### Example 10

### Water Borne Epoxy Based Polymeric Dye is Hybridized with Water Borne Based PU Resin to Get Single Pack Self-Curable Water Borne-Based Polymeric Ink System

Three kinds of water borne epoxy based polymeric dyes obtained from Preparation Example 2 are mixed with the same volume of water borne based PU resin, and 5 phr of aziridine curing agent 1,6-hexanediol bis (aziridinylpropionate) (HDDA-AZ) is added in mixture solution. These mixed inks will not dissolve in water when drying under ambient temperature and dyes in the ink also not be washed out when dipping in water. The gel content can reach to 95%.

### Example 11

Change the curing agent for TMPTA-AZ (trimethylolpropanetris(aziridinylpropionate)), the other steps and operation are the same with Example 10, the gel content of product maybe over 95%.

### Example 12

Change the curing agent for TPGDA-AZ (tripropylene glycol bis(aziridinylpropionate)), the other steps and operation are the same with Example 10, the gel content of product maybe over 95%.

### Preparation Example 3

### Preparation of Water Borne PU Based Polymeric Dye Dispersion Having Many Kinds of Dyes Pendant in the Backbone

41 g of acetone solution of PU-prepolymer obtained from Synthesis Example 1 (in 250 ml 3-neck flask), drip the acetone solution of many kinds of dyes (C. I. Disperse Blue 56, C. I. Disperse Red 4 and C. I. Disperse Yellow 9) slowly by addition funnel, and add T-12 as the catalyst, continue to react for 1 hr by mechanical stirrer. When reaction complete, use TEA to neutralize the carboxyl group and all reactant disperse in 102.5 g water. These water borne PU based polymeric dye dispersion that hanging many kinds of dyes are obtained with 20% solid. If adding 5 phr of aziridine curing agent 1,6-hexanediol bis (aziridinylpropionate) (HDDA-AZ) will improve the gel content of polymer ink films to over 95%.

### Preparation Example 4

Change the curing agent for TMPTA-AZ (trimethylolpropanetris(aziridinylpropionate)), the other steps and operation conditions are the same with Preparation Example 3, the gel content of product maybe over 95%.

### Preparation Example 5

Change the curing agent for TPGDA-AZ (tripropylene glycol bis(aziridinylpropionate)), the other steps and operation are the same with Preparation Example 3, the gel content of product maybe over 95%.

### Preparation Example 6

### Preparation of Water Borne Epoxy Based Polymeric Dye Dispersion Having Many Kinds of Dyes Pendant in the Backbone

Dripping the water solution of many kinds of water soluble dyes (one or than one dyes selected from the group of C. I. Acid Blue 62, C. I. Direct Orange 39 and C. I. Direct Red 2) slowly in 50 gm of water borne based epoxy resin obtained from Preparation Example 2) in a 250 ml 3-neck flask by addition funnel, continuing to react for 1 hr by mechanical stirrer. Water borne epoxy based polymeric dye dispersion having many kinds of dyes pendant in the backbone are obtained in an amount of 23% solid content. If adding 5 phr of aziridine curing agent 1,6-hexanediol bis(aziridinylpropionate) (HDDA-AZ) will improve the gel content of polymer ink films to over 95%.

### Preparation Example 7

Change the curing agent for TPGDA-AZ (tripropylene glycol bis(aziridinylpropionate)), the other steps and operation conditions are the same with Preparation Example 6, the gel content of product maybe over 95%.

### Preparation Example 8

Change the curing agent for TPGDA-AZ (tripropylene glycol bis(aziridinylpropionate)), the other steps and operation are the same with Preparation Example 6, the gel content of product maybe over 95%.

### Synthesis Example 6

### Synthesis of GMA-AA Copolymer

Glycidyl Methacrylate (GMA) mixed with equal volume of Acrylate acid (AA), use potassium persulfate (0.1˜0.5 wt %) as initiator, sodium dodecyl sulfate (SDS) as surfactant and water is solvent under mechanical stirrer will get GMA-AA-Copolymer by free radical polymerization.

### Preparation Example 9

### Preparation of Hanging Dye Water Borne Based GMA-AA Copolymer Dispersion

A water solution of 0.25 g water-soluble dye is added into a water solution of GMA-AA copolymer (From Synthesis Example 6) to react for 1 hr. Among those water soluble dyes comprised amino group and sulfonate, such as C. I. Acid Blue 62, C. I. Direct Orange 39 and C. I. Direct Red 2 were used, respectively.

### Preparation Example 10

### Hanging Many Kinds of Dyes of Water Borne Based GMA-AA Copolymer Dispersion Become Single Pack Self-Curable Water borne Based Polymeric Ink System

Hanging many kinds of dyes of water borne based GMA-AA copolymer 50 g (According Preparation Example 9) (Chosen dyes: C. I. Acid Blue 62, C. I. Direct Orange 39 and C. I. Direct Red 2) mixed with aziridine curing agent-HDDA-AZ (5 phr), this mixed ink will not dissolve in water when dry under ambient temperature and dye also not be washed out when dip in water. The gel content can be improved to reach 95%.

### Preparation Example 11

Change the curing agent for TMPTA-AZ (trimethylolpropanetris(aziridinylpropionate)), the other steps and operation conditions are the same with Preparation Example 10, the gel content of product maybe over 95%.

### Preparation Example 12

Change the curing agent for TPGDA-AZ (tripropylene glycol bis(aziridinylpropionate)), the other steps and operation conditions are the same with Preparation Example 10, the gel content of product maybe over 95%.

What is claimed is:

1. A manufacturing method for ambient temperature self-curable system of water borne-based polymeric ink, comprising the following steps: adding dye into water borne polymeric resin to allow color extension and using the crosslinkage reaction of polymer to make the water borne polymeric dye obtained to become water resistant after drying, characterized in reacting water soluble or solvent soluble dye having reactive amino group with water borne polymeric resin to get chemical linkage between the reactive amino group of dye and water-borne polymeric resin to allow dye to become a part of water borne polymeric material, then neutralizing said water borne polymeric material into water borne dye dispersion with tertiary amine, then adding latent polymeric cross linking agent of the water borne polymeric material to get single pack ambient temperature self-curable system of water borne-based polymeric ink.

2. The manufacturing method for ambient temperature self-curable system of water borne-based polymeric ink according to claim 1, wherein said water borne polymeric resin is one or more than one selected from the group of carboxyl groups containing polyurethane (PU) (hereinafter referred as PU based polymer), epoxy resin (hereinafter referred as epoxy based polymer) and modified acrylate copolymer resin having epoxy group (hereinafter referred as acrylate based copolymer).

3. The manufacturing method for ambient temperature self-curable system of water borne-based polymeric ink according to claim 1, wherein said PU based polymer having carboxyl groups is obtained from the addition reaction of polyglycols, dimethylol propanic acid (DMPA), and excess amount of isophorone diisocyanate (IPDI) to get water borne PU based polymer having NCO-terminated PU pre-polymer of about 4% NCO content.

4. The manufacturing method for ambient temperature self-curable system of water borne-based polymeric ink according to claim 1, wherein said epoxy based polymer is obtained from a commercial available epoxy resin with EEW (epoxy equivalent weight) 780-850 as a starting material to allow the secondary hydroxyl group of said epoxy resin react via a half-esterification with succinic anhydride or maleic anhydride, then the remaining carboxylic acid after said half-esterification is neutralized with TEA (triethylamine) to be dispersed into water phase to get water borne epoxy resin having free terminated epoxides.

5. The manufacturing method of single pack ambient temperature self-curable water borne-based polymeric ink according to claim 1, wherein said acrylate based copolymer is prepared by a copolymerization of equimolar amount of acrylic acid, glycidyl methacrylate (GMA) and alkyl acylate via free-radical polymerization process.

6. The manufacturing method for ambient temperature self-curable system of water borne-based polymeric ink according to claim 1, wherein said latent polymeric cross linking agent is one or more than one polyaziridine (polyethylenimine) selected from the group of TMPTA-AZ (trimethylolpropanetris(aziridi-nylpropionate)) and HDDA-AZ (1,6-hexanediolbis(aziridinylpropionate))).

7. The manufacturing method for ambient temperature self-curable system of water borne-based polymeric ink according to claim 6, wherein said latent curing agent is a polyaziridine containing compound, which reacts with carboxyl group of said water borne polymeric resin at ambient temperature on drying or when its pH drops to 6.0 to get a cross-linked polymeric network of polymeric dyes stable in the water borne dispersion obtained when the pH kept at over 8.0.
